(19) United States
(12) Patent Application Publication
(10) Pub. No.: US 2016/0167889 A1
(43) Pub. Date: Jun. 16, 2016

(54) METHOD FOR DETECTING THE FILL LEVEL OF A TRANSPORT SECTION

(71) Applicant: KHS GMBH, Dortmund (DE)

(72) Inventors: Ulrich SCHOLZ, Lüdinghausen (DE); Michael STREBEL, Dortmund (DE)

(21) Appl. No.: 14/902,633

(22) PCT Filed: Jun. 23, 2014
(86) PCT No.: PCT/EP2014/063097

§ 371 Date: Jan. 4, 2016

(30) Foreign Application Priority Data
Jul. 2, 2013 (DE) 10 2013 106 926.6

(51) Int. Cl. B65G 43/08; B65G 47/52

(52) U.S. Cl. CPC B65G 43/08; B65G 47/52

(57) ABSTRACT

A method for continuously detecting a fill level of a conveyor for transporting containers on a transport plane includes forming a container stream along said first transport section of the conveyor, forming a container knot at a measuring section, the container knot comprising a tightly packed multi-row stream of containers, using a first contactless distance sensor, measuring a distance from a first side of the measuring section to the container knot, and, based on the measured distance, determining a fill level of the conveyor.

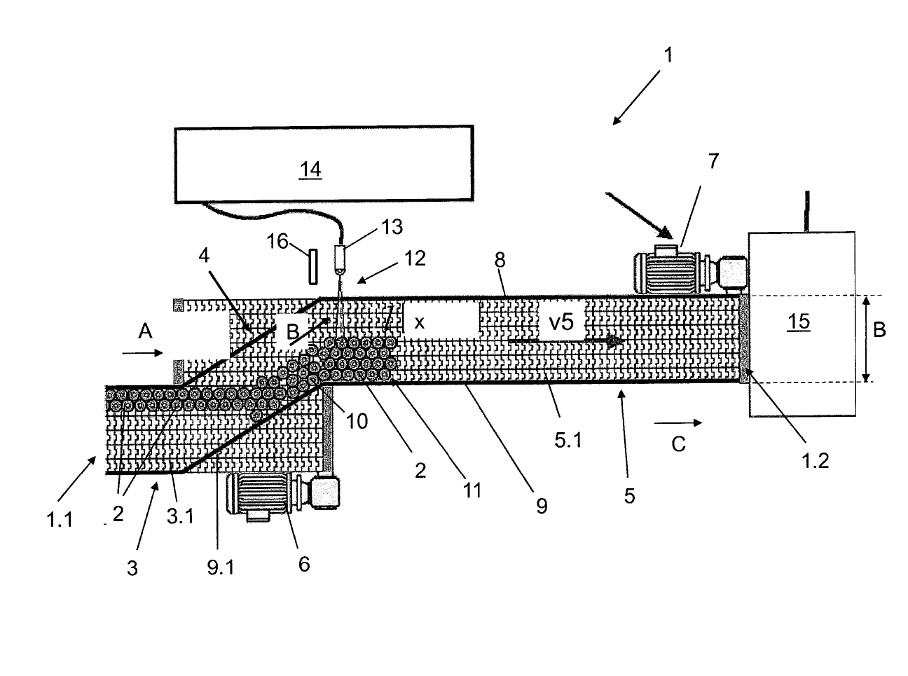

### RELATED APPLICATIONS

This is the national stage under 35 USC 371 of international application PCT/EP2014/063097, filed on Jun. 23, 2014, which claims the benefit of the Jul. 2, 2013 priority date of German application DE 102013106926.6, the contents of which are herein incorporated by reference.

### FIELD OF INVENTION

The invention relates to the transport of containers, and in particular, to detecting the fill level of a transport section for transporting containers.

### BACKGROUND

A typical conveyor carries containers from one machine to another. In most cases, it is desirable for the conveyor to maintain a steady flow rate, measured in containers per unit time. This is easy to do if containers are fed into the conveyor and taken from the conveyor at a constant rate. Unfortunately, it is not possible to guarantee that this is the case. As a result, there are often fluctuations in these quantities. These in turn interfere with maintaining a steady flow rate.

A failure to maintain a steady flow rate can have undesirable consequences. For one thing, containers can collide with each other. This creates noise and raises the risk of containers falling over. In addition, containers can exert forces on their neighbors. This leads to wear on the containers, and sometimes to damage of container decorations, such as labels.

A known way to maintain a steady flow rate is to measure the fill level of the conveyor and to adjust the conveyor speed adaptively in response to the measured fill level.

In known conveyors, one or more switches detect a fill level of a particular transport section at a transport area that is occupied by a tightly packed stream of containers. However the use of switches necessarily results in quantized measurements, with the quantization error corresponding to the number of switches.

### SUMMARY

An object of the invention is to continuously and accurately measure fill level of a conveyor or of a transport section so that a conveyor speed can be more effectively controlled.

The invention promotes the ability to know the fill level of the conveyor or transport section thereof at any time, and the distribution of containers being transported on the conveyor. This permits the transport speed of the conveyor or a transport section thereof to be adapted at any time so as to maintain an optimal output of a machine upstream or downstream of the conveyor. The invention also promotes the gentle transport of containers with reduced noise emission, optimum buffering, and increased productivity.

Embodiments of the invention include those that change the multi-row tightly packed stream of transport containers by changing the transport direction, those that do so by changing the transport speed, those that do so tilting the transport plane crosswise to the transport direction, and those that carry out any combination of the foregoing.

Embodiments also include those that determine a fill level f as a ratio between two widths: a width of the entire conveyor and a width of the unused portion of the conveyor. For example, in one embodiment, this is defined by f=(B−x)/B where x is measured and B is an overall width of the transport section. Among these embodiments are those that control transport speed of a transport section based on this determined fill level f.

Also among the embodiments are those that control transport speed of a transport section in an effort to achieve a nominal output Q of a machine following the transport section and/or of a machine that precedes the transport section.

Additional embodiments include one or more sensors that determine a transport speed of a transport section or a portion thereof. In some embodiments, these sensors collectively form a sensor unit.

Yet other embodiments periodically derive a control variable that is proportional to the continuously determined fill level. Among the embodiments that derive a control variable are those that derive it by taking into account a transport length between the measuring position and the outlet side of the transport section, those that derive it based on a mean value of fill level, and those that derive it based on any combination of the foregoing. In either case, the control variable is derived in an effort to achieve optimum control of the transport speed of the conveyor or of a transport section thereof.

Embodiments further include those that save the continuously detected fill level in a memory of a controller, a suitable memory being, for example, a shift register thereof.

In some embodiments, a transport section forms an outlet of the conveyor.

Yet other embodiments cause at least two diversions of the transport direction before the containers arrive at a section at which the fill level is determined. Among these are embodiments that divert a multi-row stream of containers twice. Such embodiments divert the stream on a first transport section moving in a first transport direction so that it flows in a second transport direction on a second transport section, and then divert the stream again so that it flows in a third transport direction on a third transport section. In these embodiments, a measuring section follows the second diversion. This is where a distance sensor measures the fill level.

Additional embodiments include those that have any combination of one or more of the foregoing features.

In one aspect, the invention features a method for continuously detecting a fill level of a conveyor for transporting containers on a transport plane, the conveyor having a first transport section that extends in a first transport direction, the first transport section having a measuring section having first and second sides and a width between the first and second sides. The method includes forming a container stream along the first transport section, forming a container knot at the measuring section, the container knot including a tightly packed multi-row stream of containers, using a first contactless distance sensor, measuring a distance from a first side of the measuring section to the container knot, and based on the measured distance, determining a fill level of the conveyor.

The formation of a container knot can be achieved in several ways. Among these are causing a transport speed of the first transport section to differ from a transport speed of a second transport section that precedes the first transport section, diverting containers from a second transport direction to the first transport direction, tilting a transport plane along which the containers are transported, wherein tilting includes tilting in a direction crosswise to the first transport direction, or any combination of the foregoing.

Practices of the invention include those in which determining a fill level includes determining a ratio between the width and a distance between the first side and the container knot.

Other practices of the invention include including controlling a transport speed of at least a portion of the conveyor based at least in part on the fill level. Among these are practices that include controlling the transport speed at least based at least in part on nominal flow rate of a container-processing machine connected to the conveyor. Such a container-processing machine can be connected upstream from the conveyor, in which case the containers are provided to the conveyor, resulting a positive value of flow rate. Or the container-processing machine can be connected downstream of the conveyor, in which case containers are removed from the conveyor, thus resulting in a negative flow rate.

Practices of the invention include those in which measuring a distance includes using a second contactless distance sensor to measure the distance.

Other practices of the invention include deriving a control variable based at least in part on the fill level. Among these practices are those in which deriving the control variable includes deriving the control variable based at least in part on a distance between the measuring position and an outlet of the conveyor, and those in which deriving the control variable includes deriving the control value at least in part based on a mean fill value that has been evaluated based on fill values stored in memory.

In some practices, the first transport section forms an outlet of the conveyor.

In some practices of the invention, forming a container stream along the first transport section includes, prior to the measuring section, causing first and second diversions of the container stream. In these practices, the first diversion diverts the container stream from a second transport direction to a third transport direction, and the second diversion diverts the container stream from the second transport direction to the first transport direction.

In other practices, forming the container stream along the first transport section includes receiving a multi-row container stream from an inlet of the conveyor, transporting the container stream along a second transport section along a second transport direction to a third transport section, transporting the container stream along the third transport section in a third transport direction, and passing the container stream from the third transport section to the first transport section prior to the measuring section.

The use of ordinal adjectives in the claims and summary does not necessarily match the corresponding use of ordinal adjectives in the detailed description. As an example, the first transport section in the claims and summary corresponds to the third transport section in the detailed description. This mismatch arises solely because the order in which components are introduced in the claims does not match the order in which they are introduced in the description.

As used herein, “containers” include cans or bottles, whether made of metal and/or plastic.

As used herein, a “tightly packed multi-row stream of containers” refers to a stream of transport containers in which the containers are adjacent to each other or lie against each other in the transport direction and crosswise to it and in which a force urges the containers against each other so that they are tightly packed.

As used herein, “container knot” refers to a cluster of containers that tends to form in the wake of a diversion in container flow and in response to the turbulence introduced by such a diversion.

As used herein, terms such as “substantially” and “approximately” refer to deviations from an exact value by ±10%, preferably by ±5%, and/or deviations in the form of changes that are not significant for function.

Further developments, benefits, and application possibilities of the invention arise also from the following description of examples of embodiments and from the figures. Moreover, all characteristics described and/or illustrated individually or in any combination are categorically the subject of the invention, regardless of their inclusion in the claims or reference to them. The content of the claims is also an integral part of the description.

### BRIEF DESCRIPTION OF THE DRAWING

The invention is explained in more detail below by means of the figure, which shows a plan view of a conveyor for transporting containers.

### DETAILED DESCRIPTION

The sole figure shows a conveyor 1 having an inlet side 1.1 and an outlet side 1.2 between which extend first, second, and third consecutive transport sections 3, 4, 5. The first transport section 3 forms the inlet side 1.1 of the conveyor 1 and transports containers in a first transport direction A at a first transport speed V3. The third transport section 5 forms the outlet side 1.2 and transports containers toward the outlet side 1.2 in a third transport direction C at a third transport speed V5. The second transport section 4 transports containers in a second transport direction B and connects the first transport section 3 to the third transport section 5.

In the illustrated embodiment, a set of first conveyor belts 3.1 forms the first transport section 3. These first conveyor belts 3.1 are preferably hinged belt chains placed side-by-side adjacent to each other along a direction perpendicular to the first transport direction A. A first drive 6 endlessly circulates the first conveyor belts 3.1 so that they move at the first transport speed V3.

Similarly, a set of second conveyor belts 5.1 forms the third transport section 5. Like the first conveyor belts 3.1, the second conveyor belts 5.1 are preferably hinged belt chains placed side-by-side adjacent to each other along a direction perpendicular to the third transport direction C. A second drive 7 endlessly circulates the second conveyor belts 5.1 so that they move at a third transport speed V5.

In the illustrated embodiment, the second transport section 4 transfers containers between the first transport section 3 and the third transport section 5. It does so in part by sharing the first conveyor belts 3.1 and the second conveyor belts 5.1. This is achieved by placing part of the third transport section 5 adjacent to part of the first transport section 3.

Although the first, second, and third transport directions A, B, C are the desired transport directions of the first, second, and third transport sections 3, 4, 5, individual containers 2 on these transport sections can temporarily move in a transport direction having a component that is perpendicular to the desired transport direction. This might occur, for example, as a result of containers 2 pushing against other containers from behind or from the side.

The first and second conveyor belts 3.1, 5.1 are arranged to form a horizontal or substantially horizontal transport plane or, in some cases, a transport plane that is slightly inclined relative to the horizontal On this transport plane, containers 2 stand upright on their respective bases. The first and second drives 6, 7 are located where the first and second conveyor belts 3.1, 5.1 reverse direction.

First and second external guide rails 8, 9 extend along the first, second, and third transport sections 3, 4, 5. These first and second guide rails 8, 9 thus follow the first, second, and third conveying directions A, B, C.

Within the second transport section 4, the second guide rail 9 forms a diverting section 9.1 that extends between the end of the first transport section 3 and the beginning of the third transport section 5. This diverting section 9.1 diverts a container stream moved by the first transport section 3 along the first transport direction A so that it moves in the second transport direction B, which runs at an angle relative to the first transport direction A. This results in a first diversion.

At the end of the second transport section 4, where the second transport section meets the third transport section 5, the container stream experiences a second diversion.

As a result of this second diversion, the containers become rearranged in a way that forms a container knot 11 in which the containers are tightly packed adjacent to each other in multiple rows, with each row parallel to the third transport direction C. A first one of these rows is closest to the second guide rail 9. A second one of these rows is adjacent to this first row but further from the second guide rail 9. Subsequent rows are adjacent to preceding rows and extend further in a direction perpendicular to the transport direction C, with each subsequent row being further from the second guide rail 9 and closer to the first guide rail 8. The exact arrangement of containers within the container knot 11 depends on the relationship between the first transport speed V3 and the third transport speed V5, as well as on a certain tilt of the transport plane crosswise to the transport direction.

The third transport section 5 includes a measuring section 12 immediately after the junction between the second and third transport sections 4, 5 where the container knot 11 tends to form. The measuring section includes a first distance sensor 13 arranged on a side of the third transport section 5 either on the first or second guide rail 8, 9. Suitable types of first distance sensor 13 are non-contacting sensors. These include ultrasound sensors or optical sensors, such as an infrared sensors. Some embodiments feature a second distance sensor 16. In these embodiments, the first and second distance sensors 13, 16 form a unit.

As the conveyor 1 operates, the first distance sensor 13 constantly measures a distance x to the container knot 11 on the measuring section 12 or on the feed side of the third transport section 5 and provides this distance to a controller 14. Based on this measured distance x and a known width B of the third transport section 5 in a direction perpendicular to its conveying direction C, which corresponds to the distance between the first and second guide rails 8, 9, the controller 14 continuously determine a fill level f of the third transport section 5. In one embodiment, it does so by evaluating a ratio between the width B of the third transport section 5 and the extent of the unused portion B-x of the transport section 5. A suitable formula relied upon by the controller 14 is

f=(B−x)/B.

Of course, there are many equivalent ways to express fill level in a way that provides a basis for control. For example, a reciprocal of the above can be used, or the above formula can be scaled by a constant. Or, for special purposes, a non-linear measure may be used. It is apparent from inspection that when the transport section 5 is completely filled, then x will be zero, which means f will become unity, and when the transport section 5 is completely empty, then x will be equal to the width B, in which case f will become zero, thus indicating an empty transport section 5. It is also of interest to note that f is a continuous variable and that the sizes of the containers are irrelevant. In fact, the above method will work even if the containers are not all the same size.

This continuously determined fill level f provides the controller 14 with a basis for controlling the overall transport speed of the conveyor 1, and in particular, for controlling the third transport speed V5 by corresponding control of the second drive 7. This permits the controller 14 to achieve a nominal output Q of a container processing machine 15 that follows the outlet side 1.2. The nominal output Q is given by a number of containers 2 that the container processing machine 15 can process processed per unit of time, for example per hour, in normal operation.

In one embodiment, the controller 14 causes the third transport speed V5 to be given by:

V5=(Q*d²*3^{1/2})/(f*B*2)

where d is the diameter of a container 2. In the case where containers are not cylindrical, as a result of which the container's diameter is not constant and may vary as a function of a coordinate along the container's vertical axis, d represents a maximum diameter. In cases where containers do not have a circular cross-section, d represents a maximum lineal dimension.

In some embodiments, the continuously detected fill level f and the transport length between the measuring section 12 and the outlet side 1.2 can be used to derive a control variable F that is a function of the fill level f to control the third transport speed V5 depending on the nominal output Q:

V5=(Q*d²*3^{1/2})/(F*B*2)

In this embodiment, the controller 14 saves the continuously detected fill level f in a memory, for example in its shift register. At specified time intervals, the controller 14 derives the control variable F from the current value of the detected fill level f stored in memory. In some embodiments, the controller 14 averages previous values of the fill level f to derive the control variable F. This results in smoother control. Such embodiments effectively implement a low-pass filtering mechanism.

The continuous detection of the fill level f makes it possible to control the transport speed of the conveyor 1 so that the containers 2 arrive at the container processing machine 15 at an optimal rate without any interruption or blockages in the container stream.

In alternative embodiments, other diverting structures can replace the diagonally running diverter 9.1 shown in the figure. An example of such a diverter is a set of one or more baffle plates.

Regardless of such modifications and variations, it is common to all embodiments that, by changing any combination of transport direction, transport speed, and transport-plane tilt on a measuring section of the transport section, one can create a container knot 11 that immediately follows one side of the transport section. This side extends in the transport direction. Using at least one contactless distance sensor, it becomes possible to measure the distance x to the container knot 11 and to use that distance as a basis for controlling conveyor speed.

Having described the invention, and a preferred embodiment thereof, what we claim as new, and secured by letters patent is:

1-11. (canceled)

12. A method for continuously detecting a fill level of a conveyor for transporting containers on a transport plane, said conveyor having a first transport section that extends in a first transport direction, said first transport section having a measuring section having first and second sides and a width between said first and second sides, said method comprising forming a container stream along said first transport section, forming a container knot at said measuring section, said container knot comprising a tightly packed multi-row stream of containers, using a first contactless distance sensor, measuring a distance from a first side of said measuring section to said container knot, and based on said measured distance, determining a fill level of said conveyor.

13. The method of claim 12, wherein forming a container knot comprises causing a transport speed of said first transport section to differ from a transport speed of a second transport section that precedes said first transport section.

14. The method of claim 12, wherein forming a container knot comprises diverting containers from a second transport direction to said first transport direction.

15. The method of claim 12, wherein forming a container knot comprises tilting a transport plane along which said containers are transported, wherein tilting comprises tilting in a direction crosswise to said first transport direction.

16. The method of claim 12, wherein determining a fill level comprises determining a ratio between said width and a distance between said first side and said container knot.

17. The method of claim 12, further comprising controlling a transport speed of at least a portion of said conveyor based at least in part on said fill level.

18. The method of claim 17, wherein controlling a transport speed comprises controlling said transport speed at least based at least in part on nominal flow rate of a container-processing machine connected to said conveyor.

19. The method of claim 12, wherein measuring a distance comprises using a second contactless distance sensor to measure said distance.

20. The method of claim 12, further comprising deriving a control variable based at least in part on said fill level.

21. The method of claim 20, wherein deriving said control variable comprises deriving said control variable based at least in part on a transport length, wherein said transport length is a distance between said measuring position and an outlet of said conveyor.

22. The method of claim 20, further comprising saving said fill value in a memory, and wherein deriving said control variable comprises deriving said control value at least in part based on a mean fill value.

23. The method of claim 12, wherein said first transport section forms an outlet of said conveyor.

24. The method of claim 12, wherein forming a container stream along said first transport section comprises, prior to said measuring section, causing first and second diversions of said container stream, wherein said first diversion diverts said container stream from a second transport direction to a third transport direction, and wherein said second diversion diverts said container stream from said second transport direction to said first transport direction.

25. The method of claim 12, wherein forming said container stream along said first transport section comprises receiving a multi-row container stream from an inlet of said conveyor, transporting said container stream along a second transport section along a second transport direction to a third transport section, transporting said container stream along said third transport section in a third transport direction, and passing said container stream from said third transport section to said first transport section prior to said measuring section.
